(19) United States
(12) Patent Application Publication
(10) Pub. No.: US 2025/0378740 A1
(43) Pub. Date: Dec. 11, 2025

(54) GAMING DEVICE INCLUDING A NUDGING ENHANCEMENT FOR AN ELECTRONICALLY DISPLAYED BONUS INDICATOR

(71) Applicant: Aristocrat Technologies, Inc., Las Vegas, NV (US)

(72) Inventors: Jeffrey Uss, Georgetown, TX (US); Kevin Walcomb, Reno, NV (US); David Marsh, Charlottesville, VA (US); Daniel Marston, Reno, NV (US); Zachary Cooper, Reno, NV (US)

(21) Appl. No.: 18/738,351

(22) Filed: Jun. 10, 2024

(51) Int. Cl. G07F 17/32; G06F 7/58

(52) U.S. Cl. CPC G07F 17/3267; G06F 7/588; G07F 17/3213; G07F 17/3265; G07F 17/329

(57) ABSTRACT

A gaming system includes a processor and a memory storing instructions thereon, wherein the instructions cause the processor to cause display of a spinning of a bonus indicator relative to a stopping position indicator, the bonus indicator including a plurality of outcome sections each including an outcome indicator displayed therein. The instructions further cause the processor to stop the spinning of the bonus indicator relative to the stopping position indicator, the stopping position indicator identifying a first outcome section of the plurality of outcome sections when spinning of the bonus indicator is stopped and cause display of a moving of the stopping position indicator on the bonus indicator from the first outcome section to a second outcome section of the plurality of outcome sections.

### TECHNICAL FIELD

The field of disclosure relates generally to electronic gaming devices, systems and methods that provide a nudging enhancement for an electronically displayed bonus indicator during game play.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, a gamins system is provided. The gaming system includes a processor and a memory storing instructions thereon, wherein the instructions cause the processor to cause display of a spinning of a bonus indicator relative to a stopping position indicator, the bonus indicator including a plurality of outcome sections each including an outcome indicator displayed therein. The instructions further cause the processor to stop the spinning of the bonus indicator relative to the stopping position indicator, the stopping position indicator identifying a first outcome section of the plurality of outcome sections when spinning of the bonus indicator is stopped and cause display of a moving of the stopping position indicator on the bonus indicator from the first outcome section to a second outcome section of the plurality of outcome sections.

In another aspect, a non-transitory computer-readable media is provided. The media contains instructions which cause a processor to cause display of a spinning of a bonus indicator relative to a stopping position indicator, the bonus indicator including a plurality of outcome sections each including an outcome indicator displayed therein. The instructions further cause the processor to stop the spinning of the bonus indicator relative to the stopping position indicator, the stopping position indicator identifying a first outcome section of the plurality of outcome sections when spinning of the bonus indicator is stopped and cause display of a moving of the stopping position indicator on the bonus indicator from the first outcome section to a second outcome section of the plurality of outcome sections.

In yet another aspect, an electronic gaming device is provided. The electronic gaming device includes a cabinet, a main display coupled to the cabinet, a mechanical topper display coupled to the cabinet, a plurality of mechanical reels configured to spin on the cabinet for display of a base game, and a game controller in communication with the main display, the mechanical topper display, and the plurality of mechanical reels. The game controller is configured to control the main display to display a spinning of a bonus indicator relative to a stopping position indicator, the bonus indicator including a plurality of outcome sections each including an outcome indicator displayed therein. The game controller is further configured to control the main display to stop the spinning of the bonus indicator relative to the stopping position indicator, the stopping position indicator identifying a first outcome section of the plurality of outcome sections when spinning of the bonus indicator is stopped, and control the main display to move the stopping position indicator on the bonus indicator from the first outcome section to a second outcome section of the plurality of outcome sections.

### BRIEF DESCRIPTION OF THE DRAWINGS

FIG. 1 is an exemplary diagram showing several gaming machines networked with various gaming related servers.

FIG. 2A is a block diagram showing various functional elements of an exemplary gaming machine.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is an example gaming device similar to the gaming device of FIG. 1.

FIG. 5 is an example screen display showing display of a feature game for display on the gaming device of FIG. 4.

FIG. 6 is a flow chart of a process for executing electronic game play for display to a user on the gaming device of FIG. 4.

FIG. 7 is an example screen display showing display of metamorphic indicators displayed during play of a base game according to the process of FIG. 6.

FIG. 8 is an example screen display showing display of a first game instance of a feature game according to the process of FIG. 6, prior to initiating a first game instance.

FIG. 9 is an example screen display showing display of the first game instance of the feature game shown in FIG. 8.

FIG. 10 is another example screen display showing display of the first game instance of the feature game shown in FIG. 8.

FIG. 11 is another example screen display showing display of the first game instance of the feature game shown in FIG. 8.

FIG. 12 is another example screen display showing display of the first game instance of the feature game shown in FIG. 8.

FIG. 13 is another example screen display showing display of the first game instance of the feature game shown in FIG. 8.

FIG. 14 is another example screen display showing display of the first game instance of the feature game shown in FIG. 8.

FIG. 15 is an example screen display showing another display of metamorphic indicators displayed prior to initiation of a second game instance of the feature game according to the process of FIG. 6.

FIG. 16 is an example screen display showing display of the second game instance of the feature game shown in FIG. 15.

FIG. 17 is another example screen display showing display of the second game instance of the feature game shown in FIG. 15.

FIGS. 18-21 show additional example screen shots of the base game and feature game of FIGS. 4-17.

### DETAILED DESCRIPTION

Described herein are systems and methods for feature games that include providing a nudging enhancement for an electronically displayed bonus indicator (e.g., a bonus wheel) during game play. The nudging enhancement may be linked to a metamorphic indicator that is displayed during play of a base game. When the feature game is triggered in conjunction with the nudging enhancement, one or more bonus wheels may be spun and stopped digitally on a main display of a gaming device relative to a stopping position indicator (e.g., a wheel pointer). The bonus wheels include a plurality of wheel sections or slices that display a feature game outcome therein, such as a credit value or jackpot award. After the bonus wheel is stopped, the wheel pointer may then be moved (i.e., nudged) one or more wheel sections to identify a new feature game outcome of the bonus wheel. In one example, the wheel pointer may be nudged one position either clockwise or counterclockwise relative to the stopped bonus wheel. The feature game may provide any suitable number of bonus games wheels displayed simultaneously, with the pointers each nudged after the spinning of the wheels is stopped. In some embodiments, the feature game may also spin a mechanical topper wheel, and optionally physically move a mechanical pointer of the mechanical topper wheel after the feature game is stopped. The stopping positions of the bonus wheels and subsequent movement of the wheel pointers may be determined according to one or more stored scripts based on a bingo game outcome. In other embodiments, the stopping positions of the bonus wheels and subsequent movement of the wheel pointers are determined based on a lookup of a weighted table including a listing of probabilities and entries identifying the initial stopping positions and movement of the wheel pointers. In some embodiments, the weighted tables or scripts are programmed such that movement of the wheel pointer may only indicate an increased award (i.e., the pointer always moves to a higher value wheel section).

The technical problems addressed herein include: (i) inability of known systems to provide display variance in accumulating credit awards resulting from an electronic bonus wheel spin; (ii) inability of known systems to display movement of a stopping wheel pointer on an electronically displayed bonus wheel, after rotation of the wheel has stopped; (iii) inability of known systems to control award outcomes resulting from an electronically displayed bonus wheel that is initially stopped at a first award outcome and a stopping wheel pointer is moved to a new award outcome after the bonus wheel is stopped; (iv) inability of known systems to move a plurality of wheel pointers for a plurality of different bonus wheels displayed simultaneously; (v) inefficient use of computer resources in known gaming systems at least because of burdensome processing requirements when determining displayed game outcomes; and (vi) lack of processing availability and speed in known gaming systems at least because of the burdensome processing requirements.

The resulting technical effect and/or technical benefits achieved herein include at least one of: (i) ability to provide display variance in accumulating credit awards resulting from an electronic bonus wheel spin; (ii) ability to display movement of a stopping wheel pointer on an electronically displayed bonus wheel, after rotation of the wheel has stopped; (iii) ability to control award outcomes resulting from an electronically displayed bonus wheel that is initially stopped at a first award outcome and a stopping wheel pointer is moved to a new award outcome after the bonus wheel is stopped (e.g., by use of one or more weighted tables or scripts as described herein); (iv) to move a plurality of wheel pointers for a plurality of different bonus wheels displayed simultaneously; (v) improved efficiency in the use of computer resources by performing a lookup of displayed game outcomes; and (vi) improved processing availability and speed at least because of the improved efficiency in the use of computer resources.

The description provided herein includes certain examples and exemplary use cases. It should be understood that these examples and use cases are included herein for illustrative purposes, and these examples and use cases should not be taken to limit the present disclosure. The systems and methods described herein may be used in many other use cases.

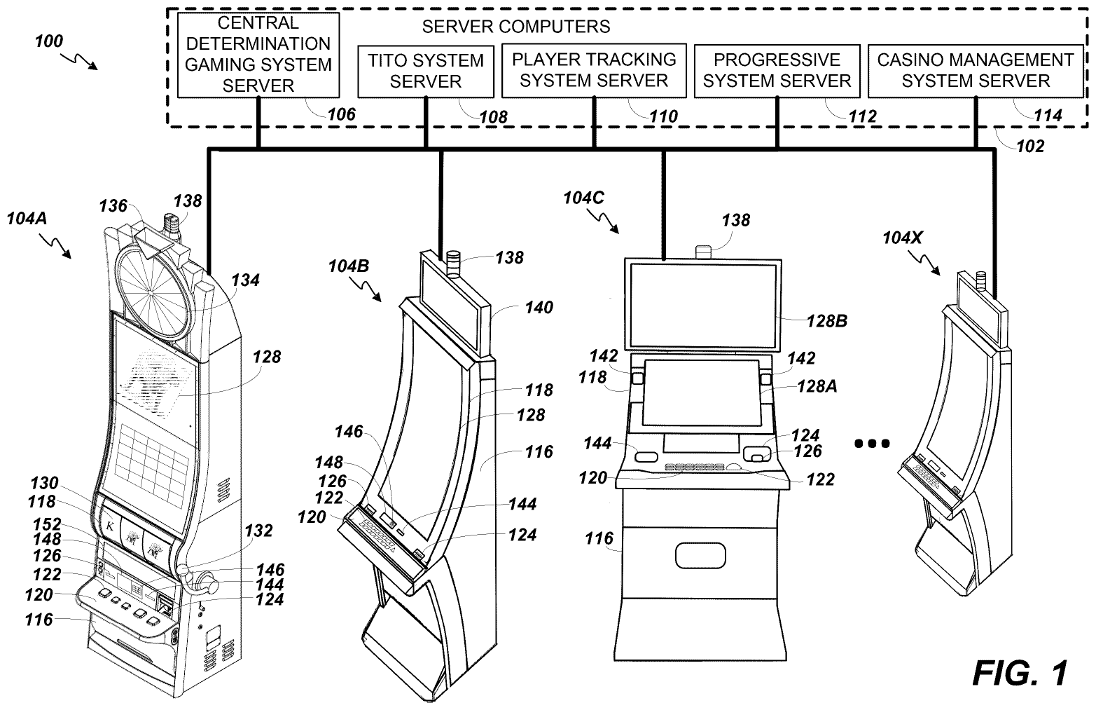

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

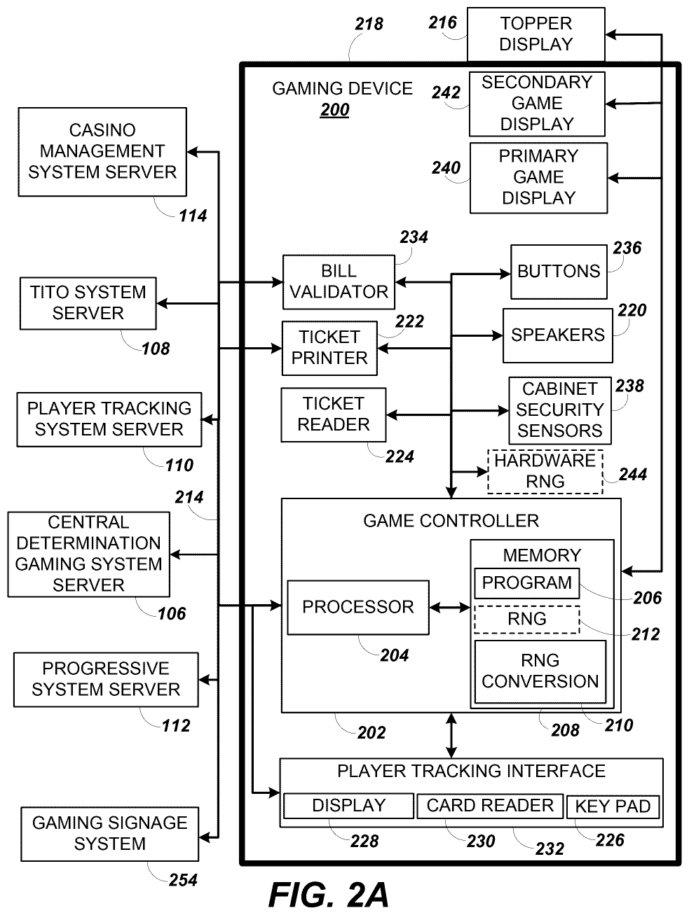

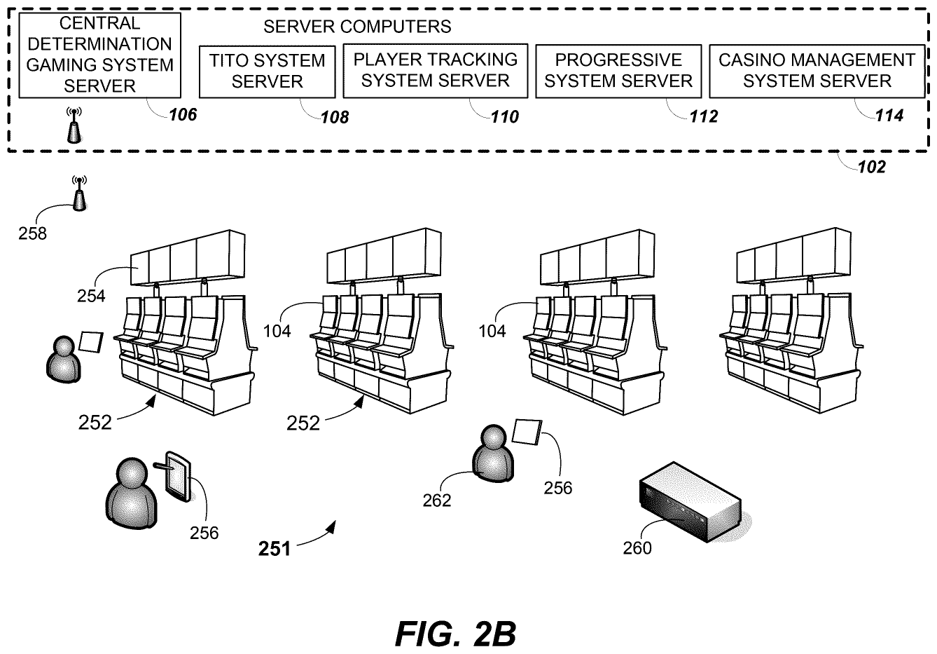

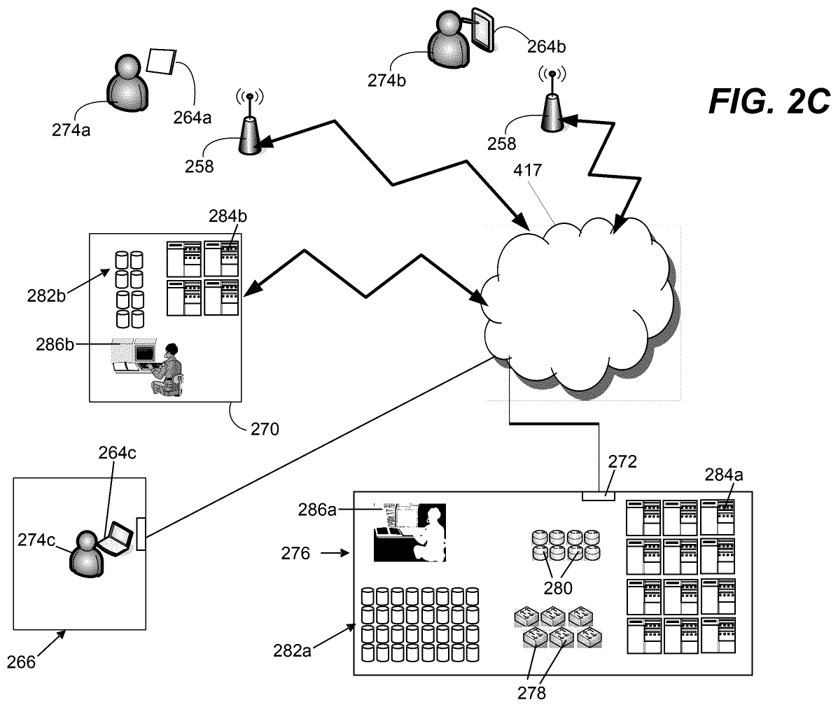

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286b. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

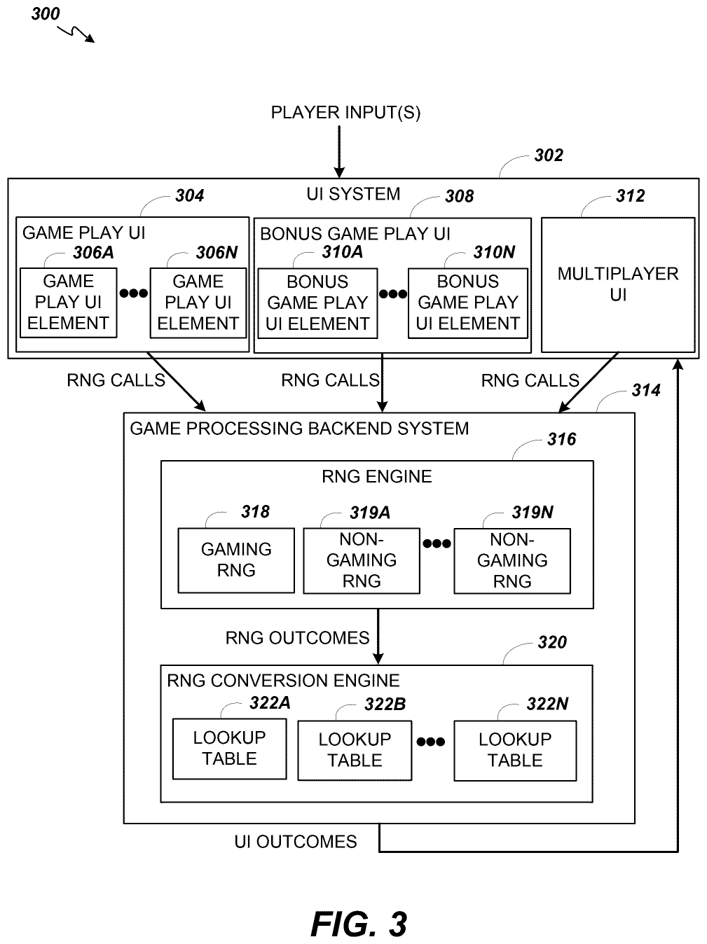

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

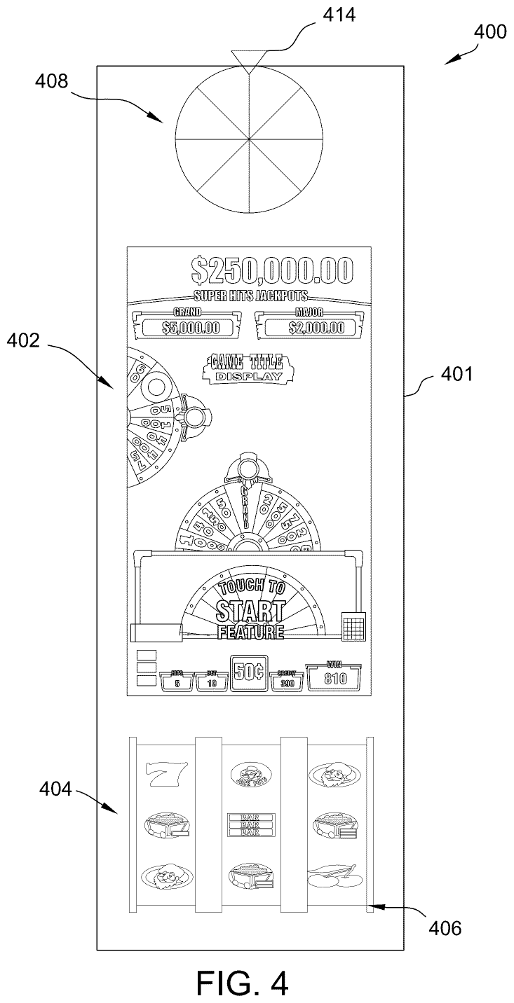

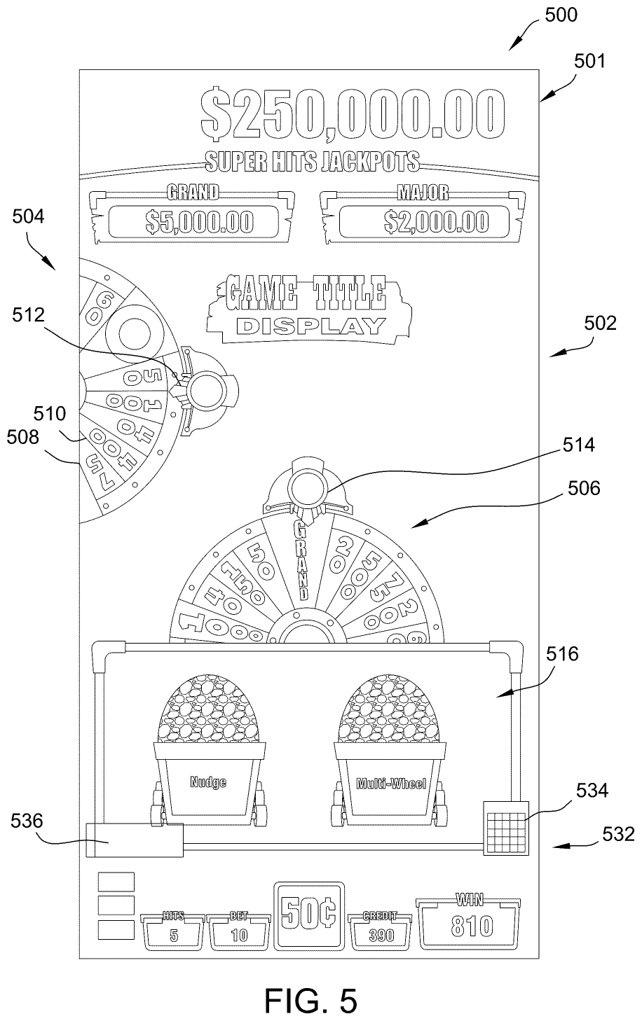

FIG. 4 is a schematic of an example gaming device 400 for executing electronic game play for display to a user. FIG. 5 shows a schematic of an example game display 500, which may be displayed on a main display 402 of the gaming device 400. The game display 500 of FIG. 5 shows a display provided during the feature game.

The gaming device 400 is similar to gaming device 104A, shown in FIG. 1 in that it includes a gaming display area 404 comprising a plurality of mechanical reels 406 (three in the example) with various symbols displayed thereon, a main display 402 (e.g., video display monitor) positioned above the gaming display area 404, and a bonus topper wheel 408. The mechanical reels 406, bonus topper wheel 408, and main display 402 are each coupled to a cabinet 401 of the gaming device 400. In other embodiments, the game play may be displayed by a mobile gaming device 256 or on any gaming device similar to gaming devices 104A-104X, shown in FIG. 1. For example, in some embodiments, the reels 406 may not be mechanical reels but may be instead be displayed on any suitable visual displayed described herein.

In the example embodiment, the game includes a base game and a feature game. The base game is a mechanical slot game in which a plurality of symbol positions are displayed to a user by the plurality of mechanical reels 406. The processor 204 configures play of the game based on a set of instructions stored in the memory 208.

The electronic game shown in FIGS. 4, 5, and 7-17 is a Class II bingo game. Referring to FIG. 5, a feature game of the electronic game is shown. The display 500 of the feature game includes a primary game display area 502 that includes one or more bonus indicators 504, 506 (also referred to herein as “bonus wheels”) that each include a plurality of outcome sections 508 (e.g., wheel slices), each having an outcome indicator 510 displayed therein. In the example, the outcome indicators 510 include credit values and Jackpot identifiers, though in other embodiments the outcome indicators 510 may include any suitable awards. The bonus indicators 504, 506 are each spun relative to a respective stopping position indicator 512, 514 that identifies a respective one of outcome sections 508.

In the example of FIG. 5, a secondary game display area 532 includes a bingo card 534 and a bingo number listing 536. As shown, bingo card 534 includes a matrix of bingo cells (e.g., squares). In some examples, the matrix may be a 5×5 matrix of 25 total cells. In some examples, bingo card 534 may have a matrix of a different size (e.g., 3×3, 4×4, 4×5, 4×6, 6×6, 7×7, 3×8, 10×10, etc.). In some examples, the matrix may be larger or smaller. In the example of FIG. 5, each cell in the matrix of bingo card 534 includes a number that is not repeated in any other cell of bingo card 534.

In some examples, the bingo game may be a networked game that involves two or more networked devices, such as gaming devices 104A-104X. For example, many electronic bingo games may be required, by state gaming regulations, to include at least two players. As a result, in these circumstances, a bingo game can only occur if two or more players have placed wagers and received a bingo card to be used to determine a game outcome against a common ball call. A ball call may be initiated once at least two players have joined an electronic bingo game (e.g., a networked electronic bingo game), and each player's bingo card (or cards) are compared to the same ball call, even where the players are physically separated, such as in different parts of a casino or even in different casinos/external locations.

Central determination gaming system server 106 may manage (and/or host) the bingo game, such as by generating bingo card 534 (or cards, as above) and/or bingo number listing 536. In some examples, bingo card 534 (and/or information on which the bingo card 534 is based), and/or the bingo number listing 536 may be generated using an RNG (e.g., RNG 318). In some examples, bingo card 534 may be randomly selected from a set of bingo cards or a player may select their own bingo card 534 (e.g., via a user interface), such as from a set of randomly generated bingo cards, for example.

In operation, a player and/or gaming device may be provided with a respective bingo card 534, such as by central determination gaming system server 106. For example, a player may be provided a new bingo card 534 each time a “Spin” or “Play” button is pressed by the player (e.g., via a user interface), provided the player has made a wager/input. In some examples, more than one bingo card 534 may be generated in response to a wager. Bingo number listing 536 (e.g., “ball call”) may be randomly generated, such as by central determination gaming system server 106. Bingo card 534 may be compared to bingo number listing 536, and the numbered cells on bingo card 534 that match numbers in the bingo number listing 536 may be marked or “daubed” on bingo card 534. Finally, the marked or daubed bingo card 534 may be evaluated against a paytable of winning bingo patterns.

Bingo number listing 536 may be continually generated until a maximum amount of numbers are listed (e.g., seventy-five numbers listed) or until a game-ending pattern is awarded to a player participating in the bingo game. A typical game-ending pattern may be a bingo card blackout pattern, in which each of the numbers of a bingo card match a number displayed in bingo number listing 536. Other game-ending patterns are also possible. When the game-ending pattern is awarded, bingo number listing 536 is reset, for all players participating in the bingo game and the process repeats. In some examples, a single play of the bingo game includes a wager, a bingo card 534, a bingo number listing 536, a matching of the numbers called with those on a bingo card 534, a determination of a bingo game outcome, and a presentation of an associated award, if any.

A bingo game outcome may be determined by comparing one or more patterns of marked (and/or “daubed) cells of bingo card 534 with a paytable of winning bingo patterns. If bingo card 534 does not include a pattern that matches a pattern in the paytable of winning patterns, then a losing bingo outcome is determined, and no award may be provided to the player. If bingo card 534 does include a pattern that matches a pattern in the paytable of winning patterns, then a winning bingo outcome is determined, and a reward may be provided to the player.

Different winning patterns may be associated with different awards. The award for a winning main bingo game outcome may be based on an amount wagered, an associated main bingo game paytable, an associated set of rules for the main bingo game, a probability (and/or likelihood) of achieving a particular bingo pattern/combination, an amount of bingo numbers needed to achieve the particular bingo pattern/combination, and/or other considerations. In some examples, the player/player account may be awarded for multiple patterns (e.g., all winning patterns) that are matched when bingo card 534 is evaluated against the paytable of winning patterns. In some examples, the player may be awarded for only the highest priority pattern (e.g., the highest paying winning pattern) that is matched. In some examples, during play of a Class II game, a player is provided or selects a single bingo card 534 for multiple plays of the bingo game, with a new bingo number listing 536 generated for each play of the bingo game. Other methods of play of a Class II bingo game, Class III games, and/or other games are also envisioned and are within the scope of this disclosure.

The bingo game outcome may be presented to the player via one or more outcomes of the mechanical reels and/or bonus game. In the example of FIG. 4 and FIG. 5, the game is simulated by spinning of the mechanical reels 406 during the base game, triggering the bonus game (also referred to herein interchangeably as a “feature game”), and providing portions of the bingo game outcome in each of the base game and the bonus game. For each play of the bingo game, the bingo game outcome is presented at least in part as a reel spin outcome in the reel game.

In the example embodiment, winning outcomes may be displayed as a combination of game outcomes in primary game display area 502 and secondary game display area 532. For example, a total bingo game outcome may be determined, followed by determination of a script or “facade” (terms used interchangeably herein) of base game display patterns/sequences and/or feature game display patterns that, in total, correspond to the determined game outcome (e.g., sequential display of the patterns/sequences of the script results in the desired game outcome being displayed/provided—in some embodiments, patterns/sequences of the script may be arranged/organized in an order from a lowest value to a highest value). In some embodiments, separate bingo game outcome determinations may be made for spins of the electronic bonus game shown in FIGS. 4-17.

In some examples, progressively increasing outputs may be applied to a Class II game as described herein. Game outputs (e.g., credit outputs) may be presented/paid from lowest to highest across a plurality of spins. A number of spins may be determined based upon an amount of a bingo game win or a number of bingo pattern wins, as examples. Sequential display of display patterns/sequences may be controlled until display/communication of a determined number of bingo pattern amounts has been achieved.

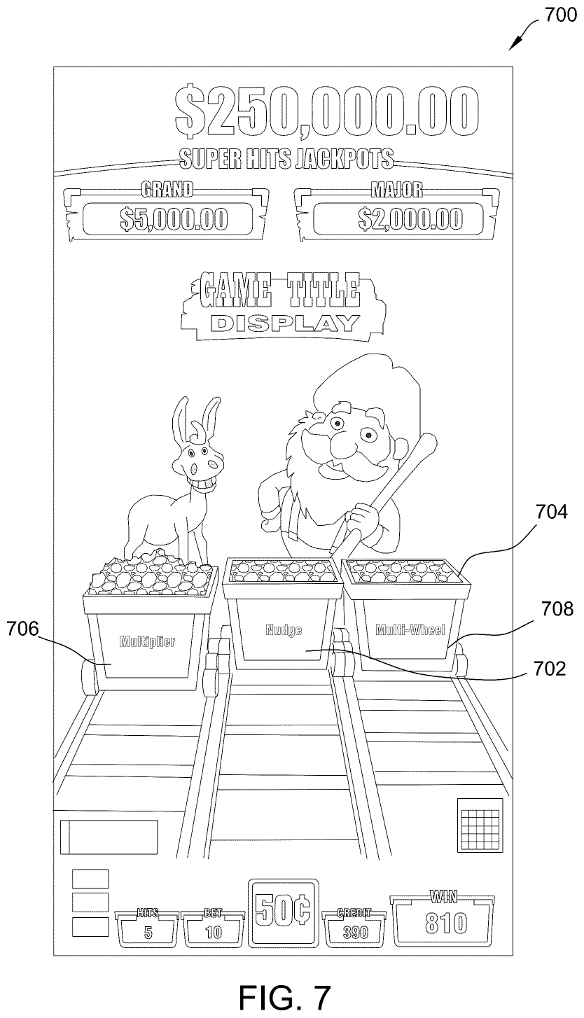

In the example embodiment, a game outcome is randomly determined (e.g., by comparing a ball call (e.g., 536) to a bingo card (e.g., 534), by use of an RNG, etc.). A lookup is then performed (e.g., by a game controller and/or based upon an RNG output) in a lookup table (e.g., 322A-N) to determine how to present the total game outcome (e.g., which script/sequence of outcomes to display). FIGS. 7-14 illustrate one particular scripted sequence, for example.

In some embodiments, a random determination may be made to determine which fractions of the total game outcome should be presented by each possible game (e.g., base game, feature game, etc.). For example, an RNG (e.g., RNG 318 and/or 319A-N) and a data structure and/or lookup table (e.g., 322A-N) may be utilized in order to make the determination of how the total game outcome should be split up amongst different game outcomes. In the example of a 100-credit outcome, the lookup table may include any number of fractions/portions/splits between a base game and/or a feature game that sum up to 100 credits. In this example, upon the random determination of how the total game outcome will be split amongst different games (e.g., 30-70, 40-60, etc.), another random determination may be made (e.g., based upon the same or a different lookup table) to determine how to display the respective fractions/portions.

For example, if the determined split is a 30-70 split between a base game and a feature game, there are a plurality of ways to display/communicate a 30-credit base outcome and a 70-credit bonus outcome. Accordingly, one or more next random determinations may be made, based upon the same or a different lookup table, to determine, continuing the example above, which base display sequence (e.g., sequence of spins and displayed symbol outcomes) to use to communicate a 30-credit base outcome and which bonus display sequence (e.g., sequence of spins and displayed symbol outcomes) to use to communicate a 70-credit feature outcome.

For example, the lookup table may be configured as a data structure and/or model such that, based upon an inputted/determined total game outcome amount, a script of which display sequence(s) to use to communicate the game outcome amount (e.g., to a player) may be determined. In some embodiments, an RNG output may be utilized to determine which script to use to communicate a particular game outcome amount. In other words, a total game outcome amount may be determined. Based upon the total game outcome amount, the lookup table can be searched for a set of scripts that correspond to that particular game outcome amount (e.g., the set of scripts may include spins/rounds of a base game, feature game, and/or bonus game, etc.). Then, an RNG output may be utilized to randomly determine which script of the set of scripts associated with the particular game outcome amount to utilize to communicate/convey the game outcome amount.

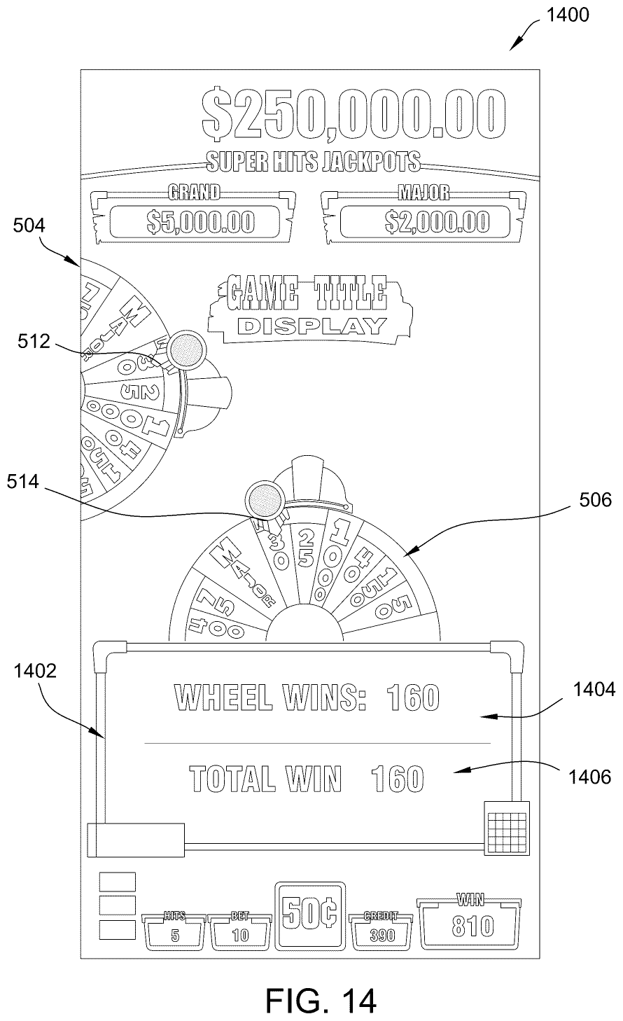

In the example embodiment, the feature game is triggered based on determination of the bingo game outcome. The feature game provides a player with one or more feature enhancements, which are displayed to the user at an enhancement display area 516. During the feature game, one or more of the bonus indicators 504, 506 (also referred to herein as “bonus wheels”) and the topper wheel 408 (shown in FIG. 4) are spun and stopping position indicators 512, 514 identify an outcome section 508 having an outcome indicator 510 that indicates an award. After all wheels 504, 506, 408 of the feature game are spun with the outcome sections indicated, an award display message 1402 is displayed to the player, as shown in FIG. 14. The total credit award corresponds to the award of the bingo game outcome. In other embodiments, the game may be a Class III type game. In such embodiments, one or more outputs of an RNG are used to determine stopping positions of the bonus indicators 504, 506.

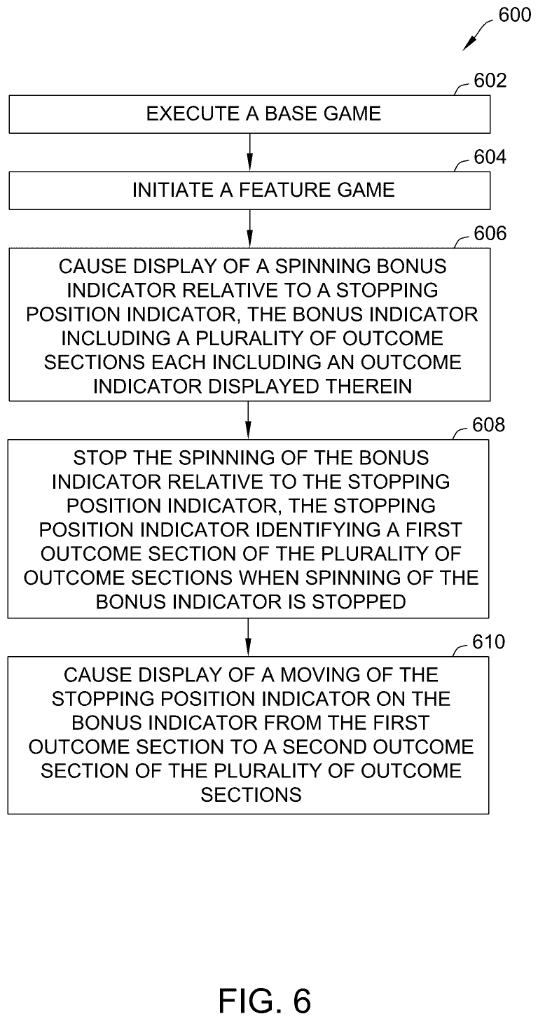

FIG. 6 shows an example process 600 of executing gameplay of the game shown in FIGS. 4, 5, and 7-17. As shown in FIG. 6, at a first step 602 of the process 600, gameplay of the base game is executed. As shown in FIG. 4, during game play of the base game, the mechanical reels 406 are each spun and stopped to provide a visual outcome of game instance outcomes.

FIG. 7 shows a game display 700 including a plurality of metamorphic indicators 702, 704, 706. Display 700 is displayed on main display 402 during play of base game. Each of the metamorphic indicators 702, 704, 706 is associated with a corresponding feature enhancement that may be applied during play of the bonus game. For example, a first metamorphic indicator 702 is associated with a “nudge” feature enhancement, a second metamorphic indicator 704 is associated with a “multi-wheel” feature enhancement, and a third metamorphic indicator 706 is associated with a “multiplier” feature enhancement.

Each of the metamorphic indicators 702, 704, 706 includes a label 708 indicating the corresponding feature enhancement. In the example the label 708 includes a text label (e.g., displaying the text “multi-wheel”) and a corresponding picture representation of the feature enhancement. Each of the metamorphic indicators 702, 704, 706 further has a different color. For example, the first metamorphic indicator 702 has a red color, the second metamorphic indicator 704 has a blue color, and the third metamorphic indicator 706 has a green color. In the example embodiment the metamorphic indicators 702, 704, 706 are each mine carts filled with gold nuggets, though in other embodiment any other suitable indicators may be used.

Referring back to FIGS. 4 and 5, the feature game includes a spinning of the bonus topper wheel 408 and one or more feature enhancements that are displayed on the main display 402, depending on the feature enhancement that is applied to the feature game. The “nudge” feature enhancement triggers the stopping position indicators 512, 514 on bonus indicators 504, 506, to move (e.g., to a higher value) after spinning of the bonus indicators 504, 506 is stopped. In some embodiments, the “nudge” feature enhancement may be applied to the topper wheel 408 (shown in FIG. 4). For example, in some embodiments, when the “nudge” feature enhancement is applied, the topper wheel 408 may be moved incrementally from an initial stopping position, to an incremented second stopping position.

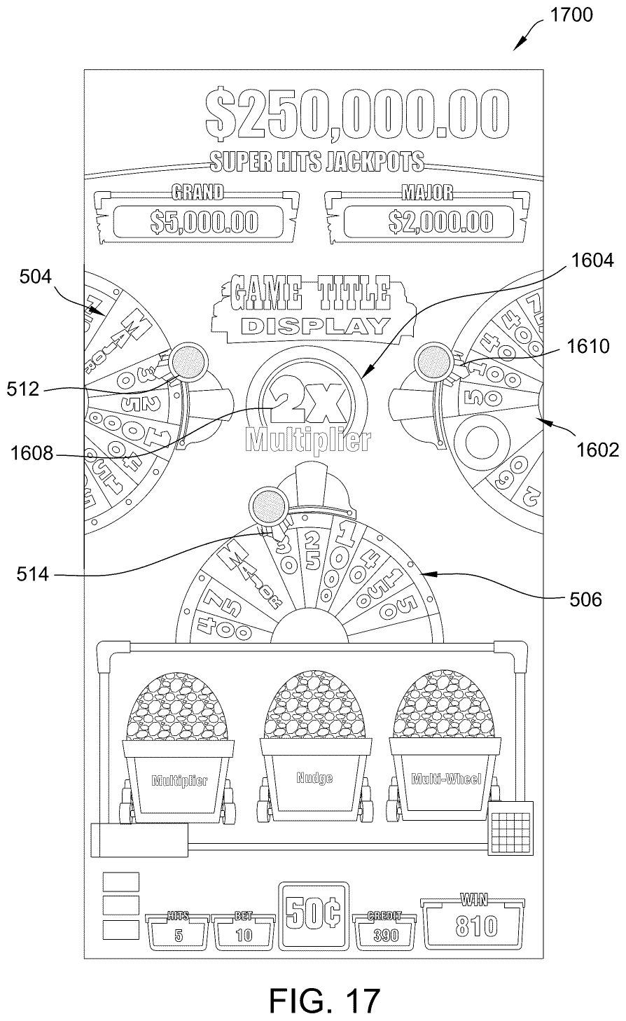

The “multi-wheel” feature enhancement triggers display of one or more bonus indicators 504, 506 on main display 402, in addition to the spinning of bonus topper wheel 408. The “multiplier” feature enhancement triggers a randomized multiplier 1608 (e.g., as shown in FIG. 17) that is used to modify any initial award of bonus indicators 504, 506 and/or topper wheel 408.

Additionally, where more than one of the feature enhancements are applied, the feature enhancements may be compounded to provide a variety of different feature game play experiences. For example, in the example embodiment, where only the “nudge” feature enhancement is applied, only bonus topper wheel 408 is spun and the nudging is applied to movement of the topper wheel 408 after initially stopped and/or to physically move a physical position indicator 414 (shown in FIG. 4). When only the “nudge” enhancement feature is applied, bonus indicators 504, 506 are not displayed and spun on main display 402. Conversely, where only the “multi-wheel” feature is applied, one or more bonus indicators 504, 506 (e.g., similar to bonus indicators 504, 506) are spun and stopped in addition to the spinning of bonus topper wheel 408, and none of the bonus indicators 504, 506 are nudged. Where both the “multi-wheel” feature and the “nudge” feature are applied, the topper wheel 408 and one or more bonus indicators 504, 506 on main display 402 are each spun and stopped and the “nudge” feature is applied to one or more of topper wheel 408 and bonus indicators 504, 506 (e.g., all in the example embodiment).

Referring to FIG. 5, the example display 500 includes an enhancement display area 516 indicating the feature enhancements that are applied to the feature game. In the example of FIG. 5, the first metamorphic indicator 702 and the second metamorphic indicator 704 are each included in the enhancement display area 516, indicating that the “nudge” enhancement and the “multi-wheel” enhancement are applied. Display 500 further includes a jackpot display area 501, displaying a listing of one or more jackpot awards.

The mechanical reels 406 (shown in FIG. 4) each include trigger symbols 410 thereon that are stylized to correspond to the metamorphic indicators 702, 704, 706. For example, in the embodiment of FIG. 4, the trigger symbols 410 include mine cart symbols that include a red mine cart symbol corresponding to the first metamorphic indicator 702, a blue mine cart symbol corresponding to the second metamorphic indicator 704, and a green mine cart symbol corresponding to the third metamorphic indicator 706. In the example embodiment, in response to one of the trigger symbols 410 occurring during the outcome of the base game, processor 204 determines whether the feature game is triggered. In the example embodiment, the feature game may be triggered based at least in part on a randomized determination, such as an RNG output and lookup table determination in a Class III embodiment, or a bingo game outcome in a Class II embodiment.

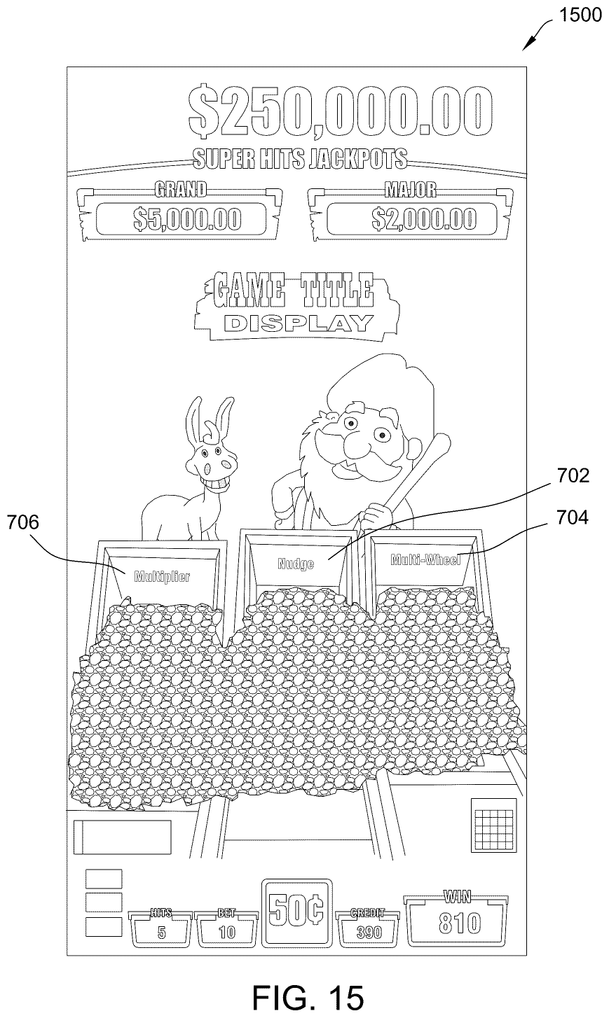

If the feature game is not triggered, one or more of the metamorphic indicators 702, 704, 706 may be advanced in correspondence with the trigger symbol 410 occurring in the base game outcome. In the example of FIG. 7, the third metamorphic indicator 706 is advanced on the tracks relative to the first and second metamorphic indicators 702, 704, 706 and gold nuggets are added to the third metamorphic indicator 706. If the feature game is triggered, the metamorphic indicators 702, 704, 706 that are associated with the triggering (e.g., by having associated symbols displayed in a base game outcome on mechanical reels 406) may be fully advanced to a triggered position, as shown in FIG. 15 for example.

Referring back to FIG. 6, at a second step 604 of the process 600, the feature game is initiated. In response to, and/or concurrently with, initiating the feature game, processor 204 determines whether and/or which feature enhancements to apply to the feature game. In the example embodiment, the game is a “wheel spin” feature game that may be triggered during and/or based on play of the base game as described herein.

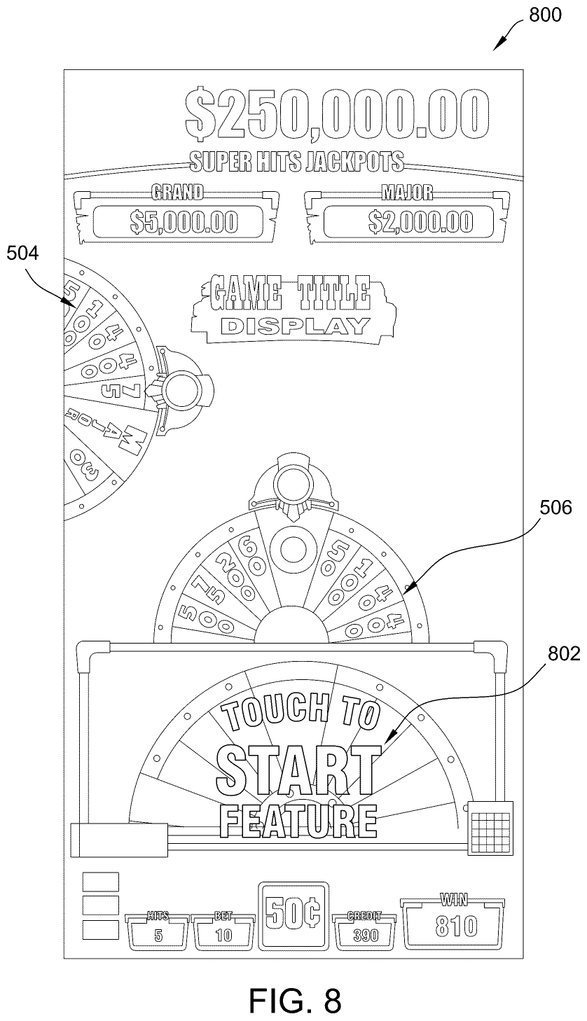

FIGS. 8-14 show game displays showing game play of a single game instance of the feature game. In the examples of FIGS. 7-14, the “nudge” enhancement feature and the “multi-wheel” feature are applied to play of the feature game.

FIG. 8 shows a game display 800 showing a “pre-spin” display 802 of feature game, i.e., prior to spinning bonus indicators 504, 506. Prior to initiating the spin of bonus indicators 504, 506, a visual effect (e.g., dimming) is applied to bonus indicators 504, 506 to indicate that they are currently inactive.

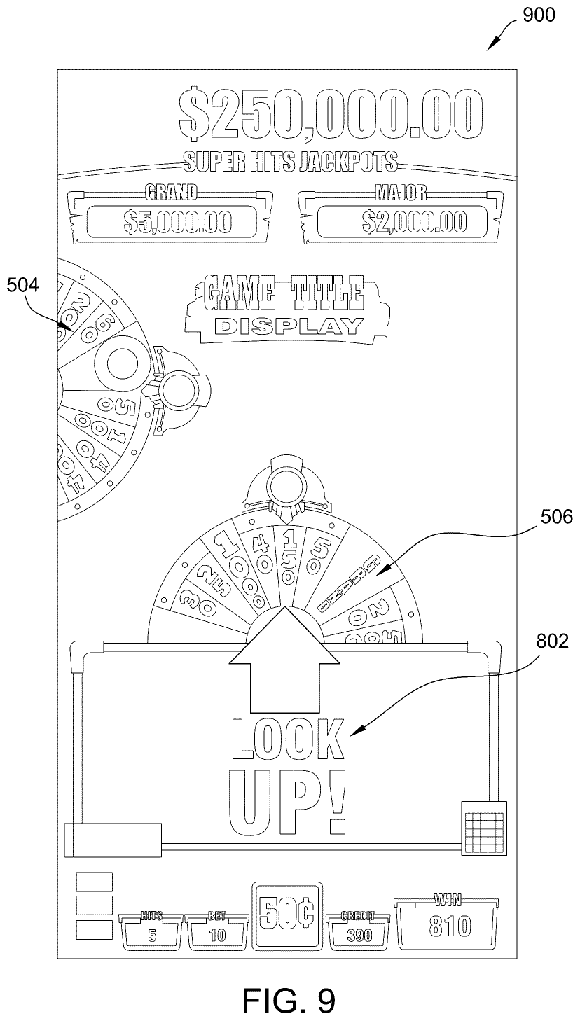

FIG. 9 shows a game display 900 immediately after the player initiates the spin. In the example, display 900 includes a look up indicator 902, indicating to a player to look up to the bonus topper wheel 408, shown in FIG. 4. In the example embodiment, bonus topper wheel 408 (shown in FIG. 4) is spun and stopped during play of the feature game to indicate an associated award in one or more outcome sections of the bonus topper wheel 408. In the game display 900, the visual dimming affect remains applied to bonus indicators 504, 506.

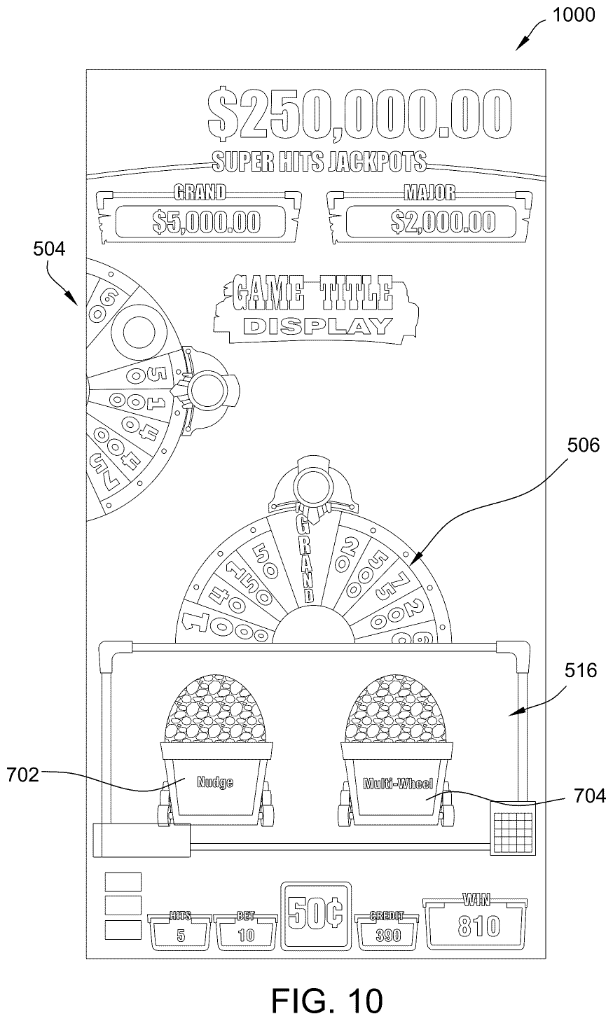

Referring back to FIG. 6, at step 606, process 600 includes causing display of a spinning bonus indicator relative to a stopping position indicator. FIG. 10 shows a game display 1000 spinning bonus indicators 504, 506, after the topper wheel 408 (shown in FIG. 4) is spun and stopped. Bonus indicators 504, 506 are each spun in the clockwise direction for at least one full rotation, though in other embodiments, bonus indicators 504, 506 may be spun in any suitable manner. In the example embodiment, enhancement display area 516 includes both the first metamorphic indicator 702 and the second metamorphic indicator 704, indicating that both the “nudge” feature and the “multi-wheel” feature enhancement are applied during play of the feature game.

In response to the “multi-wheel” feature enhancement being applied, processor 204 determines a number of bonus indicators 504, 506 to be displayed and spun during play of feature game. In the example embodiment, between one and three bonus indicators 504, 506 may be selected for the feature game, though in other embodiments any suitable number of bonus indicators 504, 506 may be used. The determination of the number of bonus indicators 504, 506 may be at least in part based on a randomized outcome, such as an RNG output or a bingo game outcome. In the example of FIGS. 8-14, two bonus indicators 504, 506 are selected and displayed.

Referring to FIG. 6, at fourth step 608 of process 600, spinning of the bonus indicator relative to the stopping position is stopped and the stopping position indicator identifies a first outcome section of a plurality of outcome sections.

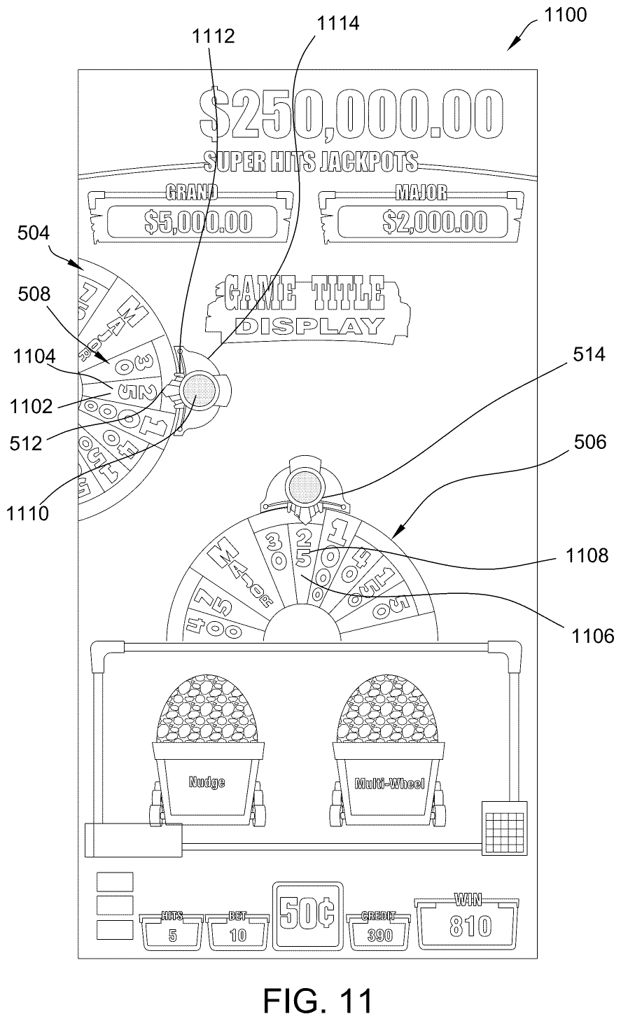

FIG. 11 shows a game display 1100 showing the first bonus indicator 504 has stopped spinning with the stopping position indicator 512 identifying a first outcome section 1102. The first outcome section 1102 includes an outcome identifier 1104 of “25,” indicating that an award associated with the first outcome section 1102 is 25 credits. The second bonus indicator 506 has also stopped spinning with the stopping position indicator 514 identifying a first outcome section 1106 of the second bonus indicator 506, also having an outcome identifier 1108 of “25”. In the example, when the first bonus indicator 504 has stopped, the second bonus indicator 506 continues to spin and is stopped after the first bonus indicator 504 has fully stopped. In other embodiments both bonus game indicators 504, 506 may be stopped generally simultaneously with one another.

Referring to FIG. 11, with the ““nudge” feature applied,” the stopping position indicator 512 further includes an illumination section 1110, a track 1112 (more broadly a “nudge path indicator”), and a base portion 1114. The track 1112 extends along the base portion 1114 and indicates a range of possible motion of the stopping position indicator 512 during the nudging. For example, in display 1100, the track 1112 spans to across the circumference of three outcome sections 508 and starts in the middle of the track 1112. Track 1112 provides a visual indication to a player that, when nudged, the stopping position indicator 512 may be moved either clockwise or counterclockwise one outcome section 508 (e.g., to the “30” credit or “1000” credit outcome sections in FIG. 11). In other embodiments, the stopping position indicator 512 may be moved more than one outcome section 508 (e.g., in the clockwise and/or counterclockwise directions) from the initial position shown in FIG. 11. In the example embodiment, the track 1112 is only displayed where the “nudging” feature enhancement is applied to the feature game.

When the bonus indicator 504 is stopped, the illumination section 1110 changes a color (e.g., from blue to white). In the example, the stopping position indicators 512, 514 and the first and second bonus indicators 504, 506 are substantially identical. In particular, the first and second bonus indicators 504, 506 each include the same number of outcome sections 508 with the same outcome identifiers 1104 presented in the same order. In other embodiments, first and second bonus indicators 504, 506 may be different from one another and include different sets and/or ordering of outcome identifiers 1104.

Referring back to FIG. 6, process 600 further includes step 610 of causing display of a moving of the stopping position indicator on the bonus indicator from the first outcome section to a second outcome section of the plurality of outcome sections.

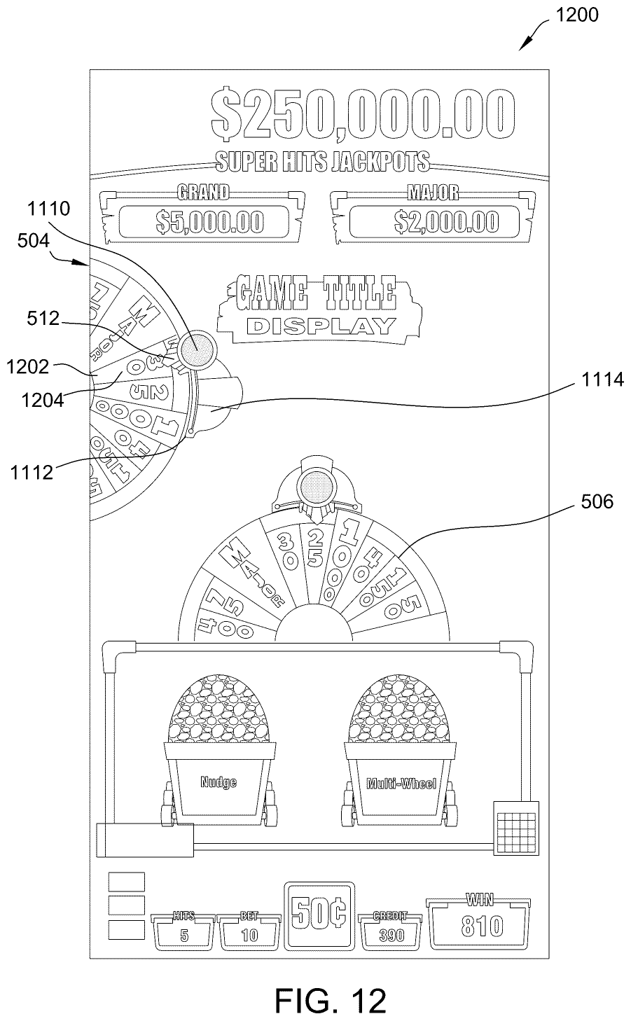

FIG. 12 shows a game display 1200 showing the stopping position indicator 512 moved relative to the bonus indicator 504 to a second outcome section 1202 of the first bonus indicator 504. In the example embodiment, the stopping position indicator 512 is moved counterclockwise from the first outcome section 1102 to the second outcome section 1202. Notably, the first bonus indicator 504 is not moved from the stopping position of the first bonus indicator 504, as shown in FIG. 11. The illumination section 1110 and the stopping position indicator 512 are each moved along the track 1112, while the base portion 1114 is maintained in the same position as shown in FIG. 11, prior to initiating the nudging. The second outcome section 1202 includes a second outcome indicator 1204 of “30” indicating that the award to the player is increased from the initial award of “25” for the first bonus indicator 504.

In the example embodiment, determinations related to initial stopping positions of the bonus indicators 504, 506 and moving of the stopping position indicators 512, 514 are associated with one another in one or more lookup tables stored on memory 208. In one Class II bingo game embodiment, memory 208 may store scripts that associate an award value with an initial selection of a stopping position of bonus indicator 504 and a directional movement of stopping position indicator 512. As an example, in some embodiments, the processor 204 may perform a lookup based on the determined bingo game outcome and, optionally, the selection of feature enhancements, such that the stopping positions of bonus indicators 504, 506 and movement of stopping position indicators 512, 514 display credit awards that equal the determined bingo game outcome or a portion thereof. In the example embodiment, the “nudge” feature enhancement only increases the award of a bonus indicator 504, such that the stopping position indicator 512 is not nudged to a lower value outcome section of the bonus indicator 504, though in other embodiments, the stopping position indicator 512 may be suitably nudged to lower or otherwise different awards.

In other embodiments (e.g., Class II embodiments), memory 208 may store one or more weighted tables (not shown) that associate an RNG output with at least one stopping position of bonus indicator 504 and subsequent movement of the stopping position indicator 512. For example, in such embodiments, the weighted tables may include a column of weighted probabilities and column including entries associated with the weighted probabilities and which indicate both the stopping position of bonus indicator 504 (e.g., stop at credit value “25”) and subsequent movement of stopping position indicator 512 (e.g., move to credit value “30”). Multiple entries may be included for each possible stopping position. For example, an additional entry in the weighted table may include the same stopping position of bonus indicator 504 (e.g., stop at credit value “25”) and a different subsequent movement of stopping position indicator 512 (e.g., move to credit value “1000”). In some such embodiments, each bonus indicator 504, 506 may be associated with substantially the same or different weighted tables as each other and separate RNG outputs may be used to perform lookups of the weighted tables. In other embodiments, determinations of the stopping position of bonus indicators 504, 506 and direction of nudge are made independently from one another and randomized (e.g., based on an RNG output or one or more bingo game outcome).

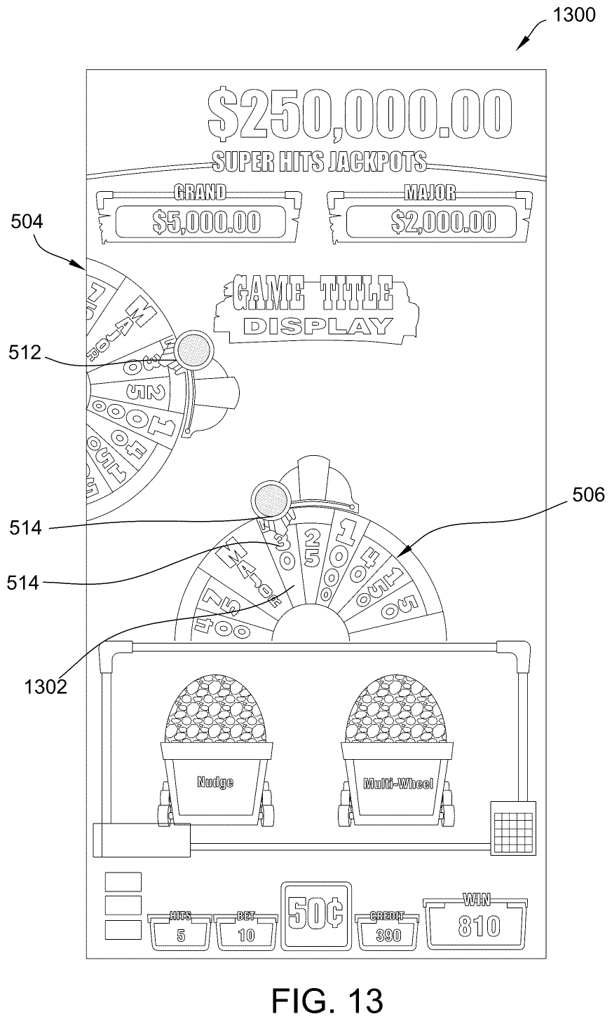

FIG. 13 shows a game display 1300 showing the stopping position indicator 514 for the second bonus indicator 506 moved to a second outcome section 1302 of the second bonus indicator 506. In the example embodiment, the stopping position indicator 514 is also moved clockwise, though the stopping position indicator 514 need not necessarily be moved in the same direction as the stopping position indicator 512 of the first bonus indicator 504.

FIG. 14 shows a game display 1400 immediately after all stopping position indicators 512, 514 have been moved, showing an award display message 1402. The award display message 1402 is displayed in response to completion of the feature game, including the spinning and stopping of all bonus indicators 504, 506. The award display message 1402 includes a total wheel wins section 1404 and a total win section 1406. In the example, the total wheel wins section 1404 and the total win section 1406 each display the same value of “160”, indicating the total wheel wins were not supplemented by any other credit awards or award enhancement features. The total wheel wins of “160” includes the sum of the awards from the first bonus indicator 504 and the second bonus indicator 506 (e.g., “30” for each) and the award from the topper wheel 408 (e.g., 100 credits in the example).

After the feature game is completed, gameplay proceeds back to the base game and any metamorphic indicators 702, 704, 706 (shown in FIG. 7) applied during the feature are reset to their initial states. In the example embodiment, metamorphic indicators 702, 704, 706 for feature enhancements not applied during the feature game (e.g., the multiplier indicator 706) are maintained in the state they were previously in prior to initiating the feature game.

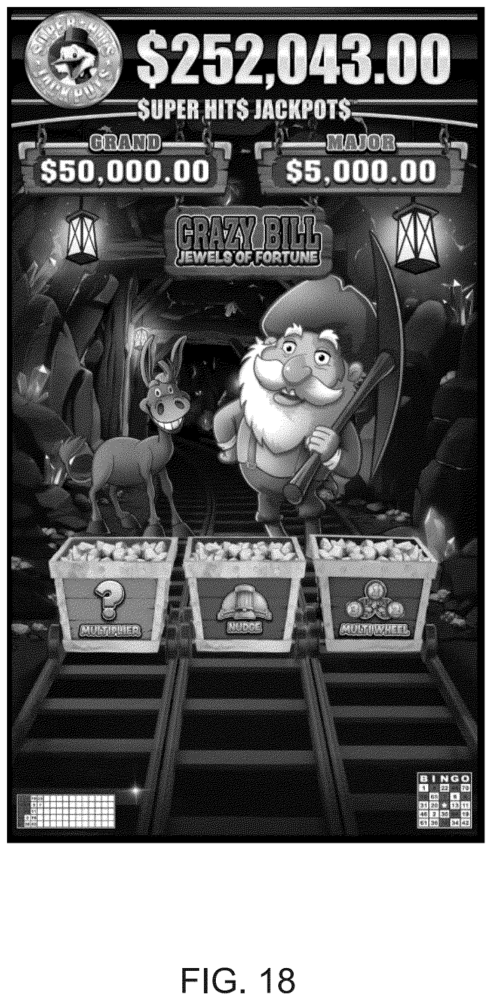

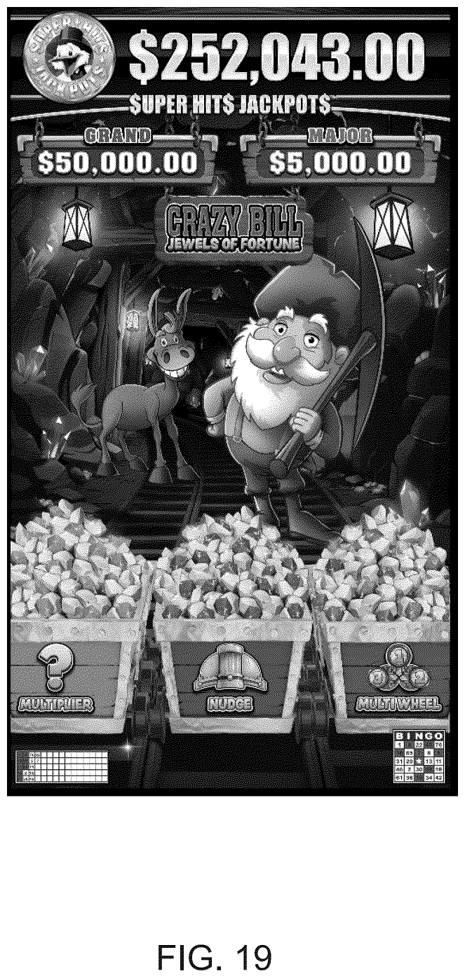

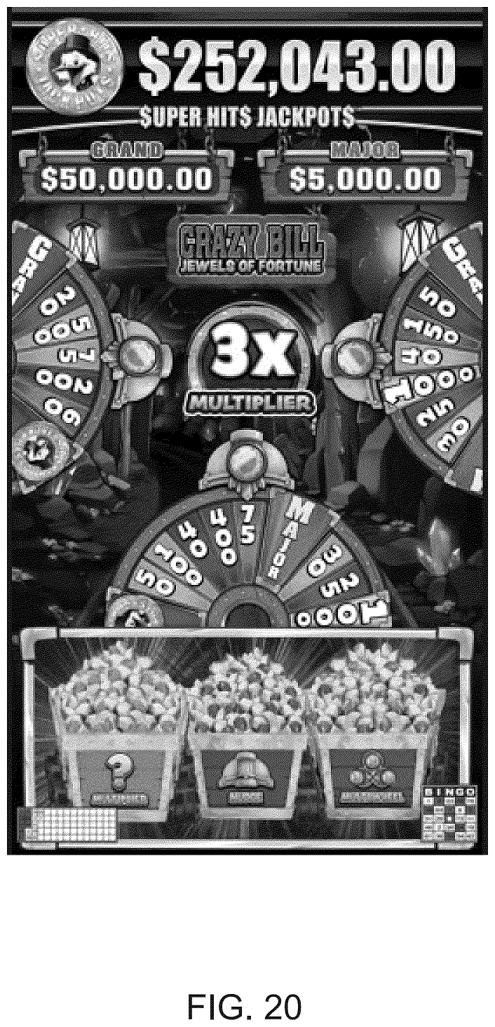

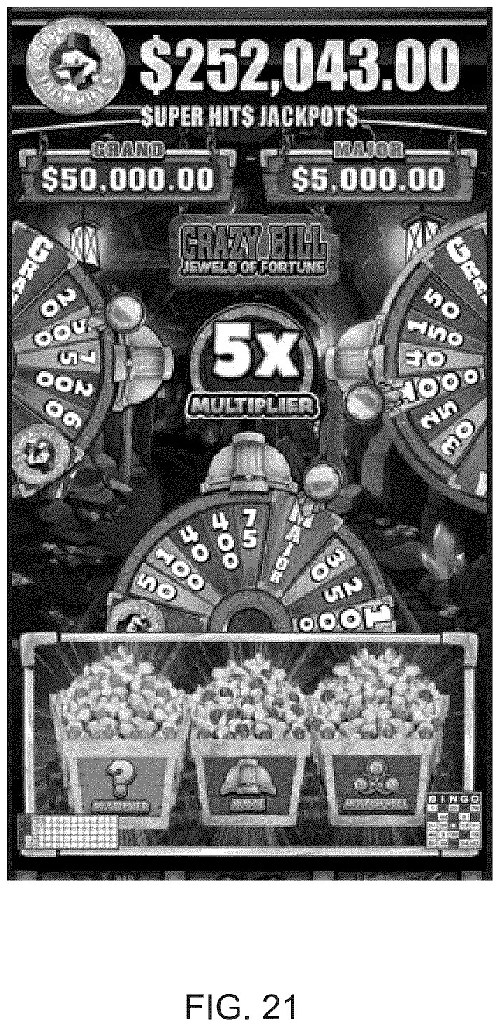

FIGS. 15-18 show a second game instance of the feature game wherein all feature enhancements (e.g., the “multiplier” enhancement, the “multi-wheel” enhancement, and the “nudge” enhancement) are applied.

Referring to FIG. 15 a game display 1500 is shown after the feature game is triggered. In the display 1500, all metamorphic indicators 702, 704, 706 are moved to a triggered state, indicating that each of the bonus feature enhancements will be applied during play of the feature game. In the example triggered state, each of the metamorphic indicators 702, 704, 706 are fully advanced along the tracks and are tipped over with gold nuggets outpouring therefrom.

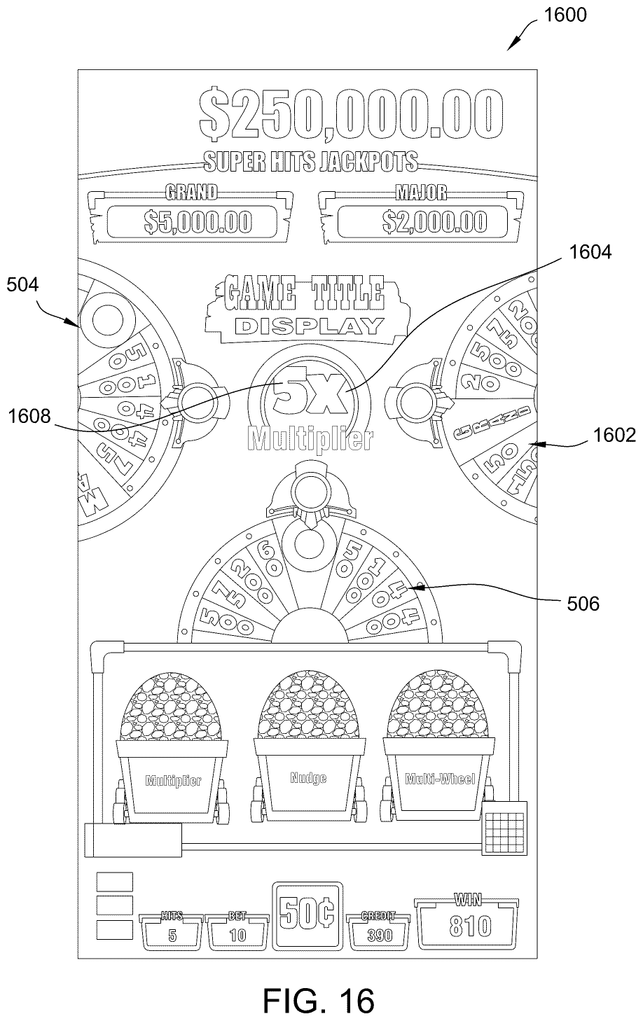

FIG. 16 shows a game display 1600 of play of the feature game instance of FIG. 15. In FIG. 16, the multi-wheel feature includes three bonus indicators 504, 506, 1602, including the first and second bonus indicators 504, 506, and a third bonus indicator 1602. The third bonus indicator 1602 is substantially the same as first and second bonus indicators 504, 506.

In the display 1600 of FIG. 16, a spinning multiplier display 1604 is also provided. The multiplier display 1604 is centrally located on display 1600 between each of the bonus indicators 504, 506, 1602 and displays a rolling list of multiplier indicators 1608 (e.g., “1×”, “2×”, “5×”, “10×”, etc.). The multiplier indicators 1608 indicate a multiplier that is to be applied to any credits awarded by the bonus indicators 504, 506, 1602 and/or topper wheel 408.

FIG. 17 shows a game display 1700 of the feature game instance of FIG. 15, showing all bonus indicators 504, 506, 1602 in the stopped position and all stopping position indicators 512, 514, 1610 nudged. In the example of FIG. 17, the first stopping position indicator 512 and second stopping position indicator 512 are each moved in the counterclockwise direction and a third stopping position indicator 1610 is moved in the clockwise direction. Additionally, the rolling of multiplier indicators 1608 on the multiplier display 1604 is stopped, revealing a final multiplier value of “2×”. The multiplier value of “2×” is applied to each of the awards associated with bonus indicators 504, 506, 1602.

The game displays shown in FIGS. 5 and 7-17 show non-limiting iterations of the feature game described herein. In other iterations, one or more different combinations of the feature enhancements may be applied.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A gaming system comprising:
a processor; and
a memory storing instructions thereon, wherein the instructions when executed by the processor, cause the processor to:
cause display of a spinning of a bonus indicator relative to a stopping position indicator, the bonus indicator including a plurality of outcome sections each including an outcome indicator displayed therein;
stop the spinning of the bonus indicator relative to the stopping position indicator, the stopping position indicator identifying a first outcome section of the plurality of outcome sections when spinning of the bonus indicator is stopped; and
cause display of a moving of the stopping position indicator on the bonus indicator from the first outcome section to a second outcome section of the plurality of outcome sections.

2. The gaming system of claim 1, wherein the instructions further cause the processor to cause display of a credit award, wherein the credit award is based on an outcome indicator of the second outcome section.

3. The gaming system of claim 1, wherein the instructions further cause the processor to determine a bingo game award, wherein the moving of the stopping position indicator on the bonus indicator is based on the bingo game award.

4. The gaming system of claim 1, wherein the instructions, when executed by the processor, further cause the processor to:
generate an output from a random number generator (“RNG”);
perform a lookup of a weighted table using the RNG output, the weighted table including a first column having a plurality of entries, each entry of the plurality of entries identifying both a stopping position of the bonus indicator and a movement of the stopping position indicator.

5. The gaming system of claim 4, wherein the instructions, when executed by the processor, further cause the processor to:
determine, based on the lookup, a stopping position of the bonus indicator and the movement of the stopping position indicator relative to the bonus indicator.

6. The gaming system of claim 5, wherein each entry of the plurality of entries causes the stopping position indicator to move to an outcome section of the plurality of sections having an outcome indicator of an increased value displayed therein.

7. The gaming system of claim 1, wherein the instructions further cause the processor to:
determine that a trigger condition for a feature game is satisfied based on a base game outcome; and
select at least one bonus feature enhancements from a plurality of bonus feature enhancements to be applied during play of the feature game based on the base game outcome.

8. The gaming system of claim 7, wherein the at least one feature enhancement includes a nudging feature enhancement, and wherein display of the moving of the stopping position indicator on the bonus indicator is performed based on selecting the nudging feature enhancement.

9. The gaming system of claim 1, wherein the instructions further cause the processor to:
cause display of a nudge path indicator, the nudge path indicator extending circumferentially over the first outcome section and the second outcome section, wherein the stopping position indicator is displayed on the nudge path indicator, and wherein causing display of the moving of the stopping position indicator includes displaying a moving of the stopping position indicator along the nudge path indicator.

10. The gaming system of claim 1, wherein the instructions, when executed by the processor, further cause the processor to:
cause, simultaneously with the display of the spinning of the bonus indicator, display of a spinning of an additional bonus indicator relative to an additional stopping position indicator, the additional bonus indicator including an additional plurality of outcome sections each including an outcome indicator displayed therein;
stop the spinning of the additional bonus indicator relative to the additional stopping position indicator; and
cause display of a moving of the additional stopping position indicator on the additional bonus indicator.

11. The gaming system of claim 1, wherein the instructions, when executed by the processor, further cause the processor to:
cause a spinning and stopping of a plurality of mechanical reels for a base game, the plurality of mechanical reels including a plurality of types of trigger symbols thereon;
determine that a trigger condition for a feature game is satisfied based on a first type of trigger symbol being present in a base game outcome; and
select a first bonus enhancement feature from a plurality of bonus enhancement features to be applied during play of the feature game based on the first type of trigger symbol being present in the base game outcome, and wherein display of the moving of the stopping position indicator on the bonus indicator is performed in response to selecting the first bonus enhancement feature.

12. A non-transitory computer-readable media containing instructions embodied thereon which, when executed by a processor, cause the processor to:
cause display of a spinning of a bonus indicator relative to a stopping position indicator, the bonus indicator including a plurality of outcome sections each including an outcome indicator displayed therein;
stop the spinning of the bonus indicator relative to the stopping position indicator, the stopping position indicator identifying a first outcome section of the plurality of outcome sections when spinning of the bonus indicator is stopped; and
cause display of a moving of the stopping position indicator on the bonus indicator from the first outcome section to a second outcome section of the plurality of outcome sections.

13. The non-transitory computer-readable media of claim 12, wherein the instructions further cause the processor to cause display of a credit award, wherein the credit award is based on an outcome indicator of the second outcome section.

14. The non-transitory computer-readable media of claim 12, wherein the instructions further cause the processor to determine a bingo game award, wherein the moving of the stopping position indicator on the bonus indicator is based on the bingo game award.

15. The non-transitory computer-readable media of claim 12, wherein the instructions, when executed by the processor, further cause the processor to:
generate an output from a random number generator (“RNG”);
perform a lookup of a weighted table using the RNG output, the weighted table including a first column having a plurality of entries, each entry of the plurality of entries identifying both a stopping position of the bonus indicator and a movement of the stopping position indicator;
determine, based on the lookup, a stopping position of the bonus indicator and the movement of the stopping position indicator relative to the bonus indicator, wherein each entry of the plurality of entries causes the stopping position indicator to move to an outcome section of the plurality of sections having an outcome indicator of an increased value displayed therein.

16. The non-transitory computer-readable media of claim 12, wherein the instructions further cause the processor to:
determine that a trigger condition for a feature game is satisfied based on a base game outcome; and
select at least one bonus feature enhancement from a plurality of bonus feature enhancements to be applied during play of the feature game based on the base game outcome, wherein the at least one feature enhancement includes a nudging feature enhancement, and wherein display of the moving of the stopping position indicator on the bonus indicator is performed based on selecting the nudging feature enhancement.

17. The non-transitory computer-readable media of claim 12, wherein the instructions further cause the processor to:
cause, simultaneously with the display of the spinning of the bonus indicator, display of a spinning of an additional bonus indicator relative to an additional stopping position indicator, the additional bonus indicator including an additional plurality of outcome sections each including an outcome indicator displayed therein;
stop the spinning of the additional bonus indicator relative to the additional stopping position indicator; and
cause display of a moving of the additional stopping position indicator on the additional bonus indicator.

18. An electronic gaming device comprising:
a cabinet;
a main display coupled to the cabinet;
a mechanical topper display coupled to the cabinet;
a plurality of mechanical reels configured to spin on the cabinet for display of a base game;
a game controller in communication with the main display, the mechanical topper display, and the plurality of mechanical reels, wherein the game controller is configured to:
control the main display to display a spinning of a bonus indicator relative to a stopping position indicator, the bonus indicator including a plurality of outcome sections each including an outcome indicator displayed therein;
control the main display to stop the spinning of the bonus indicator relative to the stopping position indicator, the stopping position indicator identifying a first outcome section of the plurality of outcome sections when spinning of the bonus indicator is stopped; and
control the main display to move the stopping position indicator on the bonus indicator from the first outcome section to a second outcome section of the plurality of outcome sections.

19. The gaming device of claim 18, wherein the controller is further configured to:
control the mechanical topper display to spin and stop on the cabinet, the mechanical topper display having an additional plurality of outcome sections each including an outcome indicator provided thereon; and
cause display of a credit award, wherein the credit award is based on an outcome indicator of the second outcome section and a stopping position of the mechanical topper display.

20. The gaming device of claim 18, wherein the controller is further configured to:
cause a spinning and stopping of a plurality of mechanical reels for a base game, the plurality of mechanical reels including a plurality of types of trigger symbols thereon;
determine that a trigger condition for a feature game is satisfied based on a first type of trigger symbol being present in a base game outcome;
select a first bonus enhancement feature from a plurality of bonus enhancement features to be applied during play of the feature game based on the first type of trigger symbol being present in the base game outcome, and wherein display of the moving of the stopping position indicator on the bonus indicator is performed in response to selecting the first bonus enhancement feature.
